(19) United States
(12) Patent Application Publication
(10) Pub. No.: US 2013/0240149 A1
(43) Pub. Date: Sep. 19, 2013

(54) HEATING DEVICE FOR CORRUGATED PAPER

(71) Applicant: Hung-Wei HUNG, New Taipei (TW)

(72) Inventor: Hung-Wei HUNG, New Taipei (TW)

(21) Appl. No.: 13/569,205

(22) Filed: Aug. 8, 2012

(30) Foreign Application Priority Data
Mar. 15, 2012 (TW) 101204667

(51) Int. Cl. B31F 1/08

(52) U.S. Cl. 156/380.9

(57) ABSTRACT

A heating device for corrugated paper is used in manufacturing process for corrugated cardboard so that the paper surface passing through the heating device may has appropriate temperature for subsequent shaping operation. The heating device of the present invention is formed by a preheat stage and a plurality of infrared lamps provided within the preheat stage. The heat generated by the infrared lamps is absorbed by the preheat stage so as to heat the surface promptly up to a working temperature suitable for the shaping operation of corrugated paper.

### BACKGROUND OF THE INVENTION

1. Field of Invention

The present invention relates to a heating device for corrugated paper used in manufacturing process for corrugated cardboard, more particularly to a heating device for corrugated paper in which infrared lamps are used as heating source for accelerating the preheating process and for controlling the corrugated paper in easy manner.

2. Related Art

FIG. 1 is a schematic view showing a conventional manufacturing apparatus for corrugated cardboard. As shown in the figure, the manufacturing apparatus 10 should conduct preheating for each paper raw material during shaping operation so as to facilitate the shaping operation. Further, the preheat process is accomplished by a plurality of heating devices (101, 101′, 101″ . . . ). Each of the heating devices (101,101′,101″ . . . ) is connected separately to a bottom linerboard conveying device 102, a core-layer conveying device 103 and a surface -layer conveying device 104. Each of the heating devices (101, 101′, 101″ . . . ) is connected to a common furnace 11 in which steam generated therein is used as the heat source for each of the heating devices (101,101′, 101″ . . . ). Forming, shaping, and conveying operations are undertaken on the paper raw materials through the conveying devices (102,103,104) after heating treatment by the heating devices (101,101′, 101″ . . . ). FIG. 2 is a schematic view showing the composition and operation of a furnace. As shown in the figure, conventional furnace 11 using kerosene as fuel generates steam after burning. As shown in the figure, the heating device 101 is in hollow-tube shape, and the steam outlet of the furnace 11 is connected to the heating device 101 to allow the interior of the heating device 101 filled with steam. In this manner, the overall heating device 101 (mainly the surface of the heating device 101) can be heated up by steam serving as the heating source. As the furnace 11 is a large-scale facility which needs a large space for set-up, accordingly the set-up cost of the furnace 11 is high, and the features of safety should be considered. Furthermore, as the heating device 101 has to accommodate the steam provided by the furnace 11, the heating device 11 itself must has a thickness enough to withstand the pressure produced by steam. It is easy to cause hazardous condition if the pressure is improperly controlled. Therefore, the heating device 101 is often made by thick and heavy material such as steel, not only the overall manufacturing cost is high but also the overall volume is bulky so as not to be conducive in assembly, replacement, and maintenance operations.

FIG. 3 is a schematic view showing the actuation of a conventional heating device. As shown in the figure, the overall heating device 101, especially its surface, can gradually reach working temperature after the interior is filled with steam so that the paper raw materials, after passing through the heating device 101, can be heated up to a temperature conducive to its shaping operation that is subsequent to the forming operation. As shown, the heating device 101 is a tube shape body with a big-area heating zone ‘a’ formed on its surface. Usually, the paper raw materials used in the manufacturing of corrugated cardboard have diversified width according to demand of desired specifications. As shown in the figure, the width of the paper material 12, approximately equal to the heating zone ‘a2’, is smaller than that of the heating zone ‘a’. So the paper material 12 only passes through heating zone ‘a2’ during conveyance, and this might result in idle state of the rest heating zones (a1,a3), that is to say, this indirectly lead to waste of energy, thus the necessary of the improvement is assured.

### SUMMARY OF THE INVENTION

In view of the above problems, the main object of the present invention is to provide a heating device for corrugated paper, which has compact dimensions, high safety, energy-saving and low set-up cost features.

In order to achieve above object, the heating device for corrugated paper of the present invention mainly comprises a preheat stage and a plurality of infrared lamps, wherein the preheat stage is mounted within the corrugated cardboard manufacturing apparatus to provide preheating treatment for the paper materials passing through it, so as to facilitate the shaping operation that is subsequent to its forming action. The infrared lamps is assembled within the preheat stage in such a manner that heat source can be promptly produced to allow the overall preheat stage reaching its working temperature after the activation of the infrared lamps. In this way, during the manufacturing process of the corrugated cardboard by the present invention, the need of energy can be remarkably reduced, the equipment set-up cost can be decreased, and the cost of space requirement can be saved. Moreover, the present invention needs no fuel or steam as the heat source, not only energy consumption can be reduced but also the overall safety of use can be raised.

### BRIEF DESCRIPTION OF THE DRAWINGS

The present invention will become more fully understood from the detailed description given herein below for illustration only, and thus are not limitative of the present invention, and wherein:

FIG. 1 is a schematic view showing a conventional manufacturing apparatus for corrugated cardboard.

FIG. 2 is a schematic view showing the composition and operation of a furnace.

FIG. 3 is a schematic view showing the actuation of a conventional heating device.

FIG. 4 is a schematic view showing the parts formation of the present invention.

FIG. 5 is a schematic view of the implementation of the present invention.

FIG. 6 is another embodiment I of the present invention.

FIG. 7 is still another embodiment II of the present invention.

FIG. 8 is yet still another embodiment III of the present invention.

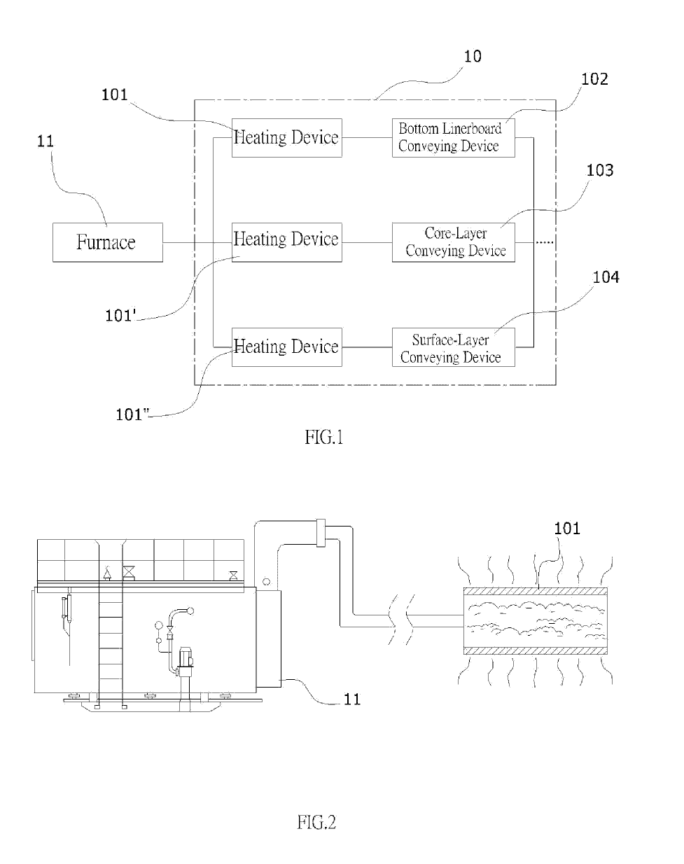

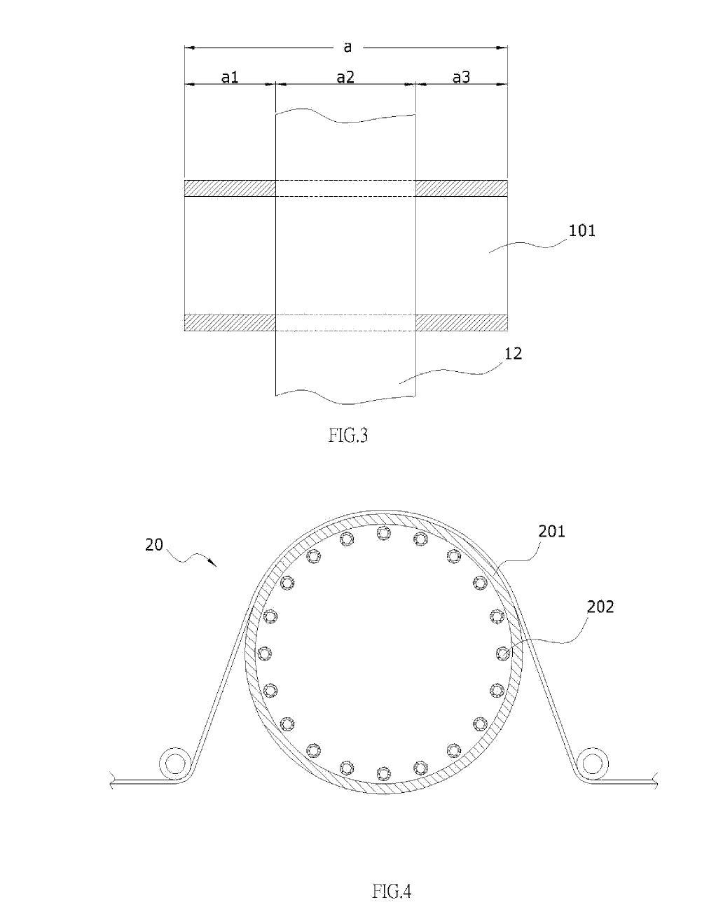

### DETAILED DESCRIPTION OF THE INVENTION

The objects, the technical contents and the expected effect of the present invention will become more apparent from the detailed description of the preferred embodiment in conjunction with the accompanying drawings.

FIG. 4 is a schematic view showing the parts formation of the present invention. As shown in the figure, a heating device 20 for corrugated paper is assembled in a corrugated cardboard manufacturing apparatus. Alternatively, several heating devices 20 can be provided according to total requirement of apparatus, and this invention is described by taking one heating device 20 as an example. The heating device 20 for corrugated paper can be in fixed state or in scrolling state. As shown in the figure, the heating device 20 for corrugated paper is formed by a preheat stage 201 and a plurality of infrared lamps 202. The preheat stage 201 is hollow in its interior and the overall shape of it can be designed as, for example, circular, semi-circular, rolling drum shape, or its surface can be designed as a curved or waved surface shape. Further, the plural infrared lamps 202 are disposed inside the preheat stage 201 respectively in such a manner that infrared lamps 202 can reach high temperature promptly and the heat energy thus produced can be transferred quickly in radiation manner to the surface of the preheat stage 201 so as to reach working temperature promptly. FIG. 5 shows a schematic view of the implementation of the present invention. As shown in the figure, infrared lamps 202 in the heating device 20 for corrugated paper are activated by the power source to generate heat promptly so as to raise the surface temperature of the preheat stage 201. Configuring in this manner, the paper material 12 can absorb the heat quickly when passing through the surface of the preheat stage 201, so as to facilitate the subsequent forming and shaping operations. Summing up above, this invention takes advantage of the infrared lamps 202 to produce heat; as the infrared lamps 202 have light-weight and compact features and they are installed within the preheat stage 201, not only the set-up cost of the overall apparatus can be saved but also the installation space of the heating space can be reduced. Since the infrared light emitted from the infrared lamps 202 is served as the heat source for the preheat stage 201, no such pollution as waste-gas is produced besides electric output. Furthermore, there is no need for relevant pressure control; hence the safety in operation can be significantly increased.

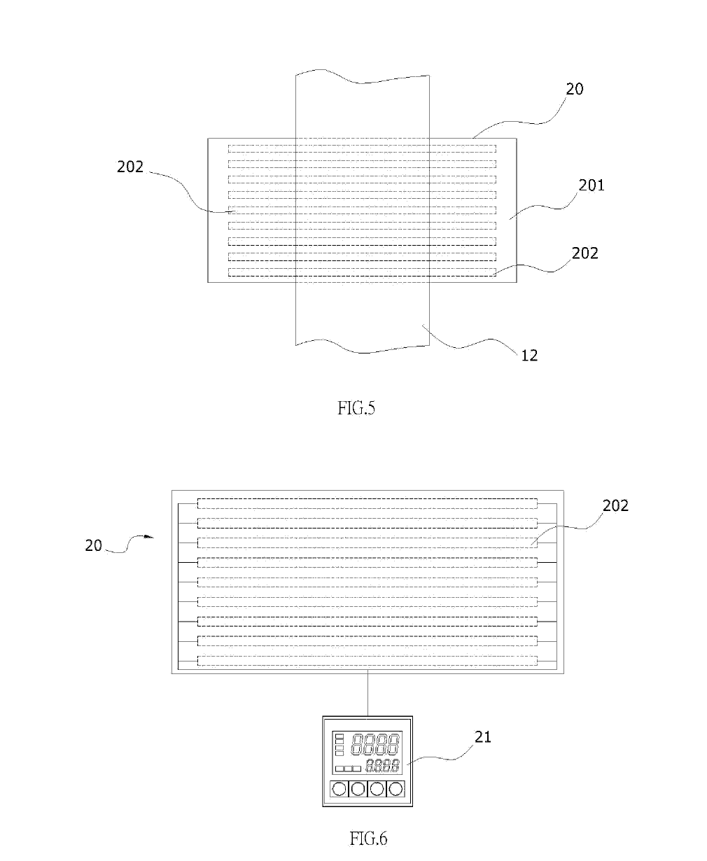

FIG. 6 is another embodiment I of the present invention. Referring to the figure, the paper thickness and the paper feeding speed are different in the manufacturing process of the corrugated cardboard according to demands. For example, if the paper thickness changes, then the required working temperature has to be changed too. Further, a necessary requirement on the working temperature is nothing more than its stability. In the present invention, a plurality of infrared lamps 202 are used as the heating source which can reach high temperature promptly and a temperature controller 21 is further electrically connected to each infrared lamp 202 for activation control thereof. Therefore, the working temperature can be controlled effectively according to different kinds, dimensions, and thickness of the paper materials. For example, when a paper of large thickness is used to manufacture corrugated cardboard, the temperature generated by the infrared lamps 202 can be increased by the temperature controller 21; on the other hand, when a paper of small dimension is used, the infrared lamps 202 only within proper area are activated by the temperature controller 21 and the rest infrared lamps 202 in the zone without passing by paper remain inactivated. In this manner, not only the stability of high-quality corrugated cardboard can be guaranteed but also the purpose of energy-saving can be achieved.

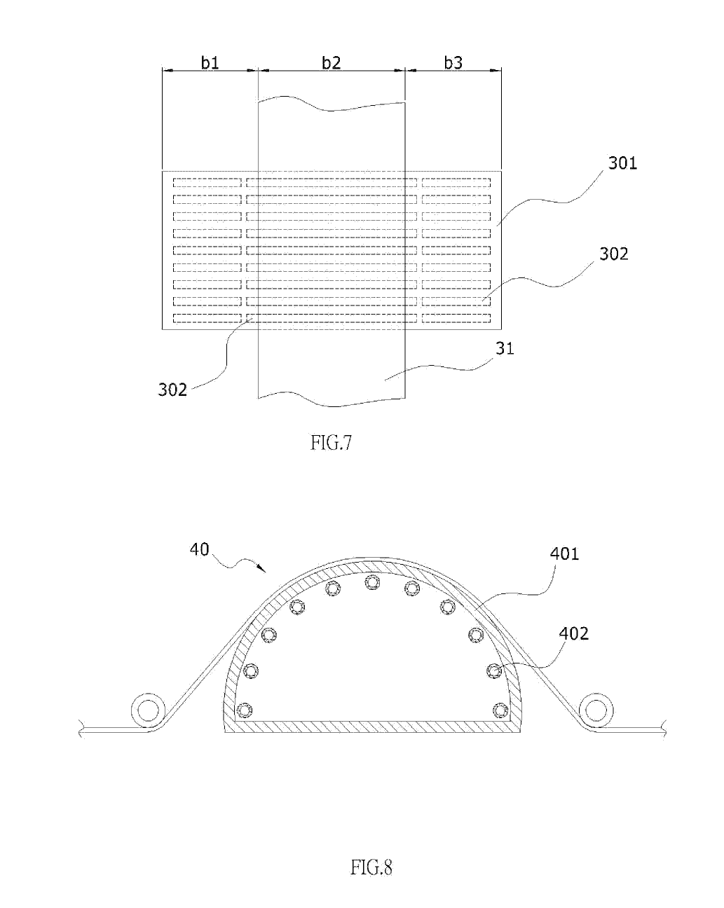

FIG. 7 is still another embodiment II of the present invention. In this embodiment, a plurality of infrared lamps can be arranged in such a manner that the preheat stage has multi-segment heating areas. Referring to the figure, a plurality of infrared lamps 302 disposed within the heating device 30 for corrugated paper are arranged in such a manner that a plurality of heating zones (b1, b2, b3) are formed on the surface of the preheat stage 301. The width of the paper material 31 as shown in the figure is approximately equal to the width of the heating zone b2. Operator can activate each of the infrared lamps 302 assembled in the heating zone b2 through external control device (such as power source controller, temperature controller) so that the heating zone b2 can be heated up. In this manner, operator can activate desired heating zones (b1, b2, b3) to be heated up according to the width of the paper material used. For example, if the paper width covers the heating zones (b1, b2, b3), then all the heating zones (b1, b2, b3) are activated. On the other hand, if the paper width covers only a part of the heating zones (b1, b2, b3), only part of the heating zones (b1, b2, b3) is activated so as to achieve energy saving.

FIG. 8 is yet still another embodiment III of the present invention. From the abovementioned description, as the conventional heating device uses steam produced by the furnace as the heat source for the preheat stage, the tube wall thickness of the preheat stage has to be maintained at a certain value so as to prevent the preheat stage from being endangered of cracking due to incapability of withstanding the steam pressure. Referring to the figure, the preheat stage 401 of the heating device 40 of the present invention is made into various shapes according to need, such as semi-circular shape in the figure, and a plurality of infrared lamps 402 are provided within the preheat stage 401. As the present invention takes advantage of infrared lamps 402 as the heat source, so the tube wall of the preheat stage 401 is merely maintained at a minimum thickness. In this manner, the shape of the preheat stage 401 can be designed according to operator's need; hence the present invention has the advantage of wide applicability.

Based on foregoing, since the infrared lamps are served as the heat source, energy and installing space can be saved, pollution is eliminated in operation, and hence the safety in operation can be significantly increased. Therefore, the purpose of providing a heat device for corrugated paper with compactness in volume, high safety in operation, energy-saving effect, and low set-up cost can be achieved by the implementation of the present invention.

While the present invention has been described by preferred embodiments in conjunction with accompanying drawings, it should be understood the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

What is claimed is:

1. A heating device for corrugated paper, incorporated in a corrugated cardboard manufacturing apparatus and used for the heating up of paper materials so as to facilitate the subsequent forming and shaping operations, wherein the heating device comprises:
a preheat stage with a hollow cavity inside thereof;
more than one infrared lamps assembled within the preheat stage in such a manner that heat source can be promptly produced for the heating up of the surface of the preheat stage when the infrared lamps are activated; and
wherein the paper materials passes through the surface of the preheat stage by conveying devices.

2. The heating device for corrugated paper as claimed in claim 1, wherein the infrared lamp is electrically connected to a temperature controller.

3. The heating device for corrugated paper as claimed in claim 1, wherein the infrared lamps are arranged within the preheat stage in such a manner that a plurality of heating zones are formed on the surface of the preheat stage.

4. The heating device for corrugated paper as claimed in claim 3, wherein each of the infrared lamps is electrically connected to a temperature controller separately.

5. The heating device for corrugated paper as claimed in claim 1, wherein the preheat stage has a semi-circular appearance.

6. The heating device for corrugated paper as claimed in claim 1, wherein the preheat stage has a circular appearance.

7. The heating device for corrugated paper as claimed in claim 1, wherein the preheat stage has an appearance of a rolling drum.

8. The heating device for corrugated paper as claimed in claim 1, wherein the preheat stage has an appearance of curved surface.

9. The heating device for corrugated paper as claimed in claim 1, wherein the preheat stage has an appearance of waved surface.
